(19) United States
(12) Patent Application Publication
(10) Pub. No.: US 2024/0247822 A1
(43) Pub. Date: Jul. 25, 2024

(54) ICE-MISTING COOLING FAN

(71) Applicant: Weijinghui E-Commerce (Shenzhen) Co., Ltd., Shenzhen (CN)

(72) Inventor: Liang Wang, Shenzhen (CN)

(21) Appl. No.: 18/591,171

(22) Filed: Feb. 29, 2024

(30) Foreign Application Priority Data
Feb. 1, 2024 (CN) 202420247157.3

(51) Int. Cl. F24F 6/14; F24F 5/00; F24F 6/00; F24F 13/20; F24F 140/00

(52) U.S. Cl. CPC F24F 6/14; F24F 5/0021; F24F 13/20; F24F 2006/008; F24F 2140/00

(57) ABSTRACT

Disclosed is an ice-misting cooling fan, including a fan frame, where a first misting device is arranged inside the fan frame; the first misting device is provided with a first placing opening, a second placing opening, a cold air outlet, a first drainage opening and a second drainage opening; the first placing opening and the second placing opening are covered by an end cover that is movably connected to the fan frame; a fan is arranged on an outer side of the cold air outlet; a base is arranged at the bottom of the fan frame, and a second misting device is arranged at a position of the base relative to the fan, and a water collection tank is arranged at a position of the base relative to the first drainage opening; and the second misting device is provided with a water inlet and an air outlet.

### TECHNICAL FIELD

The present disclosure relates to the technical field of cooling fans, and particularly relates to an ice-misting cooling fan.

### BACKGROUND

Misting fans on the market in recent years are new types of fans that combine liquid storage containers and misting devices on the basis of traditional fans. When fan blades rotate, a misting device is controlled to suck liquid (such as water) from a liquid storage container, and to spray water in the form of mist into an airflow field formed by the rotation of the fan blades. In summer, the misting fan filled with water, due to the principle of water gasification, can achieve a better effect of heat removal and cooling for human bodies.

To achieve a good cooling effect, ice blocks can be added to the liquid in the liquid storage container to further reduce the temperature of liquid spraying and improve the cooling effect, which is similar to the technical solution provided by a Chinese invention patent with the application No. CN200610035372.3. The product thereof is relatively convenient to use overall and has a certain cooling effect, but when an ice-water mixture is atomized and sprayed through a misting system, it is easy to cause the problems mainly as follows: firstly, when the ice water mixture is subjected to high-frequency vibration, a atomized gas, compared with the ice-water mixture, is significantly hotter, because energy conversion occurs when atomized particles are vibrated, and the cooling effect is far inferior to that of true ice; secondly, crystal particles of the ice-water mixture easily block the air outlets of atomizing sheets, reducing the service life of an atomization system; thirdly, when all lower water level misting devices on the market do not work, misting sheets will be leaked and dripping, and water drops will fall on a surface of a worktable and wet documents and other items thereon, thus bringing trouble and inconvenience to the user; and fourthly, products in the prior art are simple in structure and function, and cannot meet the growing customer demand. In view of this, the present disclosure provides an ice-misting cooling fan of a new structure.

### SUMMARY

An objective of the present disclosure is to provide an ice-misting cooling fan, in order to overcome the defects in the prior art, to meet the practical needs, and to solve the above technical problems.

In order to achieve the above objective, the present disclosure provides the following technical solution: an ice-misting cooling fan, including a fan frame formed by movably assembling an upper fixed base, a lower fixed base and a plurality of support columns, where a first misting device is arranged inside the fan frame; the first misting device is provided with a first placing opening, a second placing opening, a cold air outlet, a first drainage opening and a second drainage opening; the first placing opening and the second placing opening are covered by an end cover that is movably connected to the fan frame; a fan is arranged on an outer side of the cold air outlet to guide the circulation of cold air, and columns, where the fan is movably connected to the fan frame; a base is arranged at the bottom of the fan frame, and a second misting device is arranged at a position of the base relative to the fan in a pull-out manner, and a water collection tank is arranged at a position of the base relative to the first drainage opening in a pull-out manner; and the second misting device is provided with a water inlet and an air outlet, where the water inlet is connected with the second drainage opening through a switching valve.

Preferably, a set of rotating protrusions is arranged on a circumferential outer wall of the fan, and the rotating protrusions are movably connected to the support columns; and a first rotating notch is formed at a position of an inner wall of the upper fixed base relative to the fan, and a second rotating notch is formed at a position of an inner wall of the lower fixed base relative to the fan, where the second rotating notch and the first rotating notch form a movable cavity of the fan.

Preferably, the first misting device includes an ice box and a water tank that are fixedly connected, and the first placing opening is formed at the top of the ice box; the cold air outlet is arranged on a front side of the ice box; the first drainage opening is formed on the lower fixed base; the second placing opening is formed at the top of the water tank; and the second drainage opening is formed at the bottom of the water tank.

Preferably, the first misting device further includes a housing arranged along a normal line of an intersection between the ice box and the water tank, a cotton core mounting cavity is formed inside the hollow housing, an atomizer is fixedly installed at the top of the housing, and an opening is formed at a position of the end cover relative to a nozzle of the atomizer.

Preferably, a through hole is formed on at a position of the lower fixed base relative to a connecting angle between the ice box and the water tank, an air guide socket is arranged at a position on a surface of the atomizer relative to the through hole, an end portion of the air outlet is sleeved with an exhaust hose, and an end of the exhaust hose penetrates through the through hole and is in fit with the air guide socket in an inserted manner.

Preferably, the second misting device includes an internally hollow mounting base, and a plurality of atomizing sheets are arranged on the top of the mounting base; a liquid level sensor is arranged at a low point relative to the atomizing sheets inside the mounting base, and the liquid level sensor is in signal connection to the switching valve; and the water inlet is arranged at a low end of a back side of the mounting base, and the air outlet is arranged at a high end of a back side of the mounting base.

Preferably, working positions of the atomizing sheets are arranged on a front side of the fan.

Preferably, at least one heat dissipation device is arranged on a side surface of the fan frame.

Compared with the prior art, the present disclosure has the beneficial effects as follows:

The present disclosure, by constructing a portable and multifunctional cooling fan, meets market demand, and through the first misting device, a humidification state can be implemented separately; through use of true ice, is different from other ice-water cooling fans currently available on the market, guarantees the emission of cold air and achieves more durable and efficient cooling effect; and another humidification state with the cooling effect can be implemented through the cooperation of the second misting device and the fan. The present disclosure not only has rich and novel functions, beautiful structure and operation convenience, and t and novel functions, which is advantageous for market promotion.

### BRIEF DESCRIPTION OF THE DRAWINGS

FIG. 1 is a schematic diagram of an overall structure of the present disclosure.

FIG. 2 is a front view of a working structure of the present disclosure.

FIG. 3 is a rear view of a working structure of the present disclosure.

FIG. 4 is front view of breakdown of an overall structure of the present disclosure.

FIG. 5 is a rear view of breakdown of an overall structure of the present disclosure.

FIG. 6 is a semi-sectional view of an overall structure of the present disclosure showing a motion range of a fan.

FIG. 7 is a top view of a partial structure of the present disclosure.

FIG. 8 is a bottom view of a partial structure of the present disclosure.

FIG. 9 is a schematic diagram of a structure of a second misting device of the present disclosure.

In the figures: 1. fan frame; 2. upper fixed base; 3. lower fixed base; 4. support column; 5. first misting device; 6. end cover; 7. fan; 8. base; 9. second misting device; 10. water collection tank; 11. heat dissipation device; 12. switching valve;

201. first rotating notch; 202. second rotating notch;

301. through hole;

501. first placing opening; 502. second placing opening; 503. cold air outlet; 504. first drainage opening; 505. second drainage opening; 506. ice box; 507. water tank; 508. housing; 509. atomizer; 510. air guide socket;

701. rotating protrusions;

901. water inlet; 902. air outlet; 903. mounting base; and 904. atomizing sheets.

### DETAILED DESCRIPTIONS OF THE EMBODIMENTS

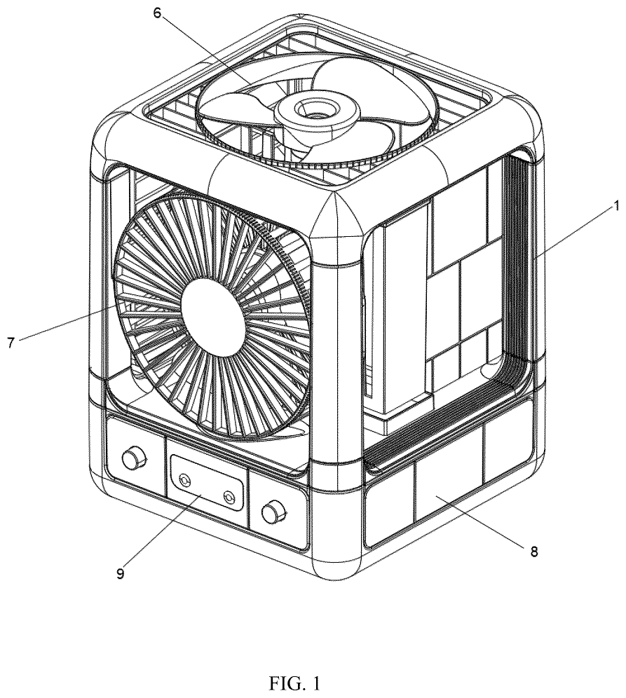

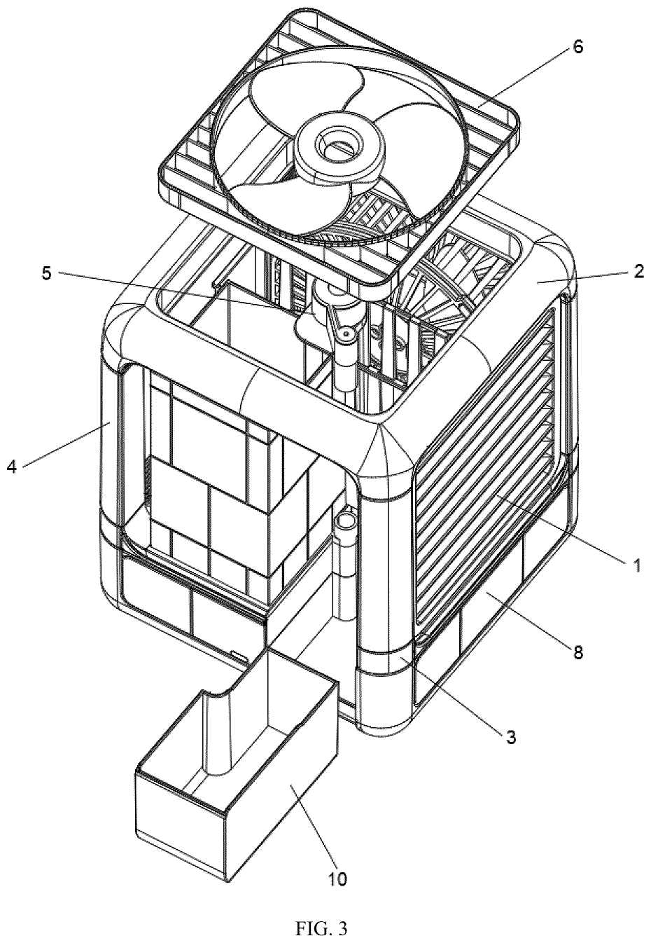

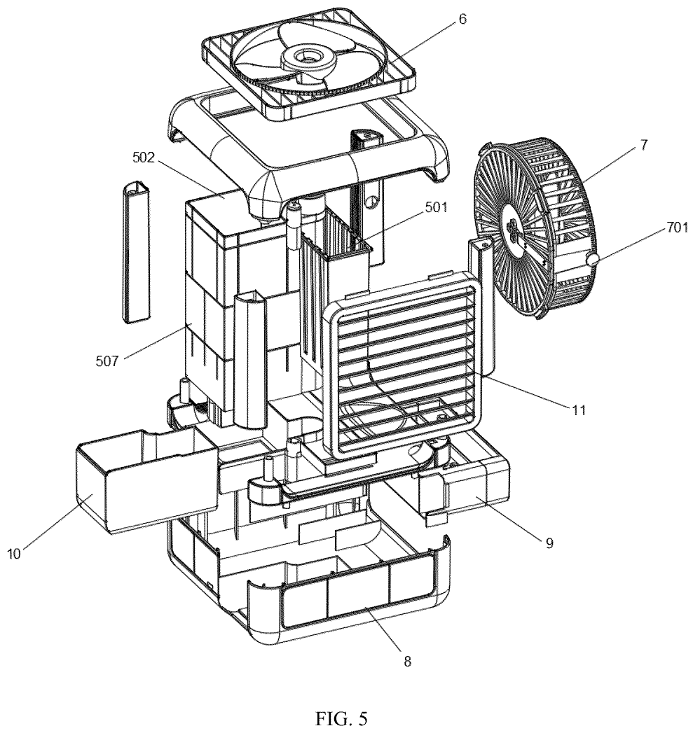

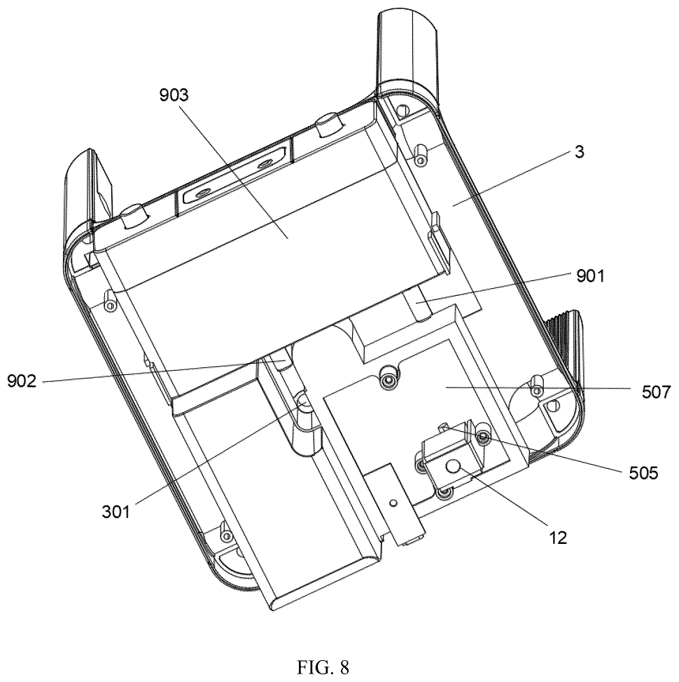

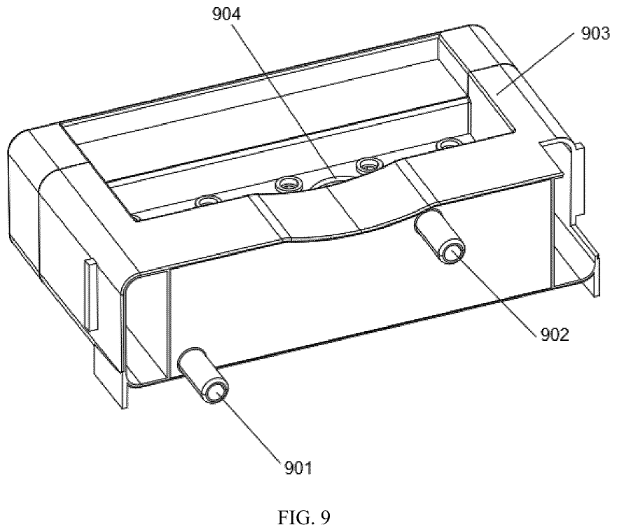

The present disclosure will be further described below with reference to FIGS. 1-9 and embodiments.

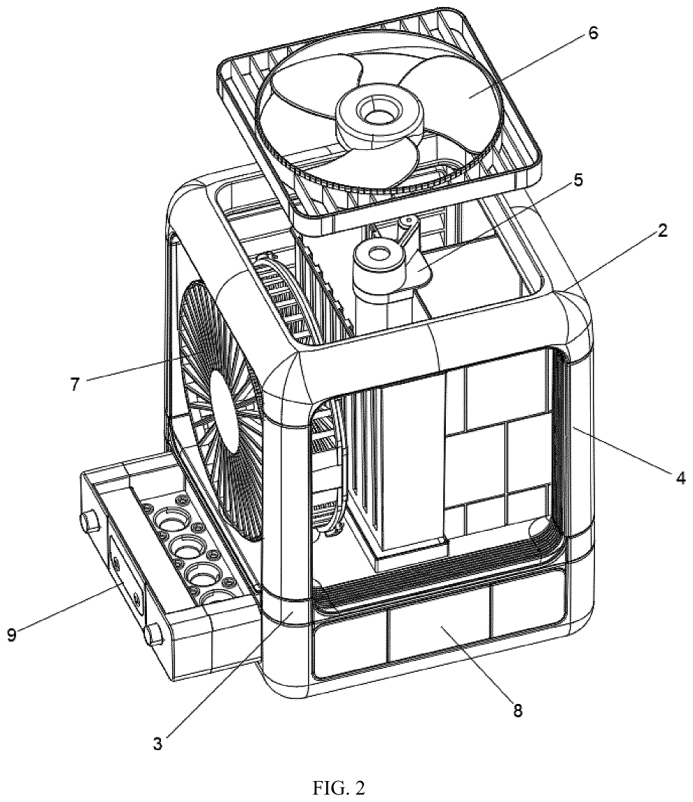

Embodiment: An ice-misting cooling fan, as shown in FIGS. 1 and 2, includes a fan frame 1 formed by movably assembling an upper fixed base 2, a lower fixed base 3 and a plurality of support columns 4, where the fan frame 1 has a size of 16 cm*16 cm*23 cm, and a first misting device 5 is arranged inside the fan frame 1.

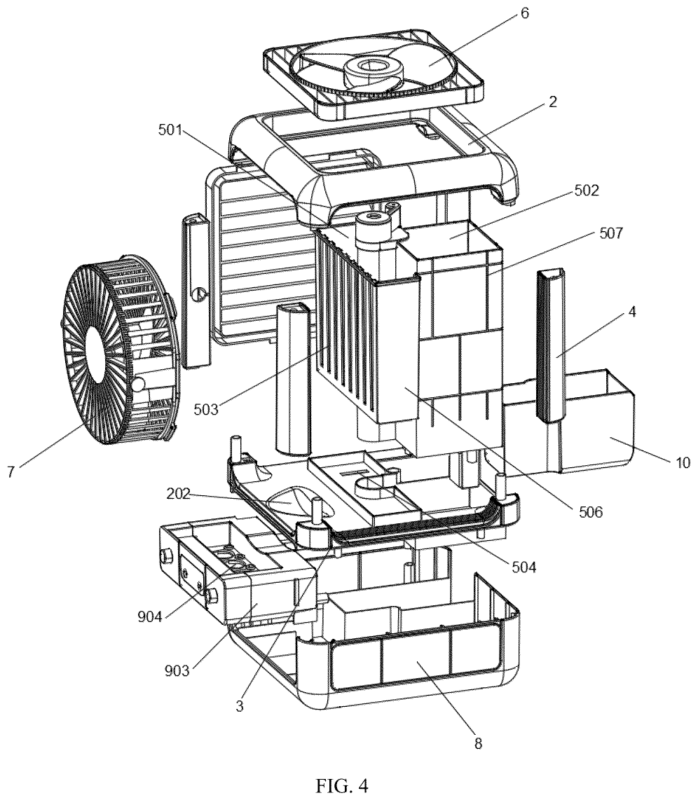

As shown in FIGS. 4-8, the first misting device 5 is provided with a first placing opening 501, a second placing opening 502, a cold air outlet 503, a first drainage opening 504 and a second drainage opening 505, where the first placing opening 501 and the second placing opening 502 are covered by an end cover 6 that is movably connected to the fan frame 1, and in a specific embodiment, the end cover 6 can be decorated with a fake fan to beautify its appearance.

Specifically, the first misting device 5 includes an ice box 506 and a water tank 507 that are fixedly connected, and the first placing opening 501 is formed at the top of the ice box 506 to place ice into the ice box 506; the cold air outlet 503 is arranged on a front side of the ice box 506 to facilitate the diffusion on an ice-air phase side; the first drainage opening 504 is formed on the lower fixed base 3 to facilitate the flow of ice water when ice melts into water; the second placing opening 502 is formed at the top of the water tank 507 for injecting water into the water tank 507; and the second drainage opening 505 is formed at the bottom of the water tank 507 to facilitate the flow of water inside the tank 507. Further, the first misting device 5 further includes a housing 508 arranged along a normal line of an intersection between the ice box 506 and the water tank 507, and a cotton core mounting cavity is formed inside the hollow housing 508 to place cotton cores left after atomization and water absorption; an atomizer 509 is fixedly installed at the top of the housing 508, and an opening is formed at a position of the end cover 6 relative to a nozzle of the atomizer 509, to facilitate the atomization and spraying of water in wet cotton cores through high-frequency vibration. Through this structure, a humidification state can be implemented separately.

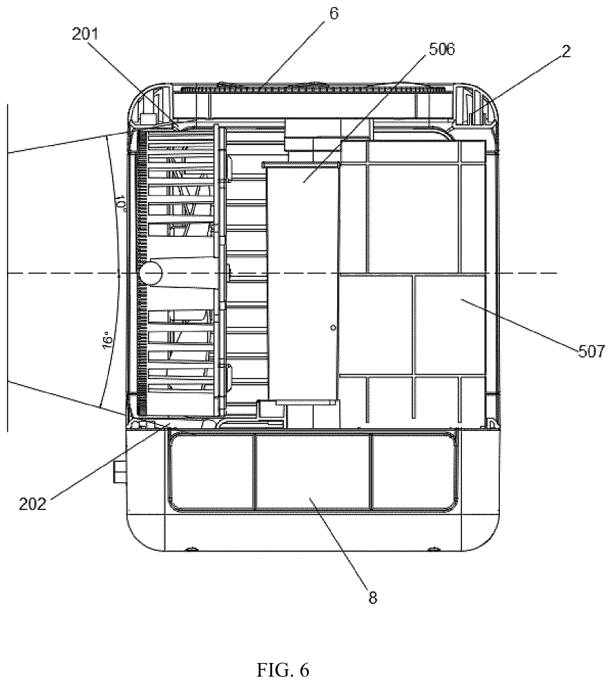

As shown in FIGS. 2, 4 and 6, a fan 7 is arranged on an outer side of the cold air outlet 503 to guide the circulation of cold air, and when being diffused from the ice box 506, ice air (i.e. cold air) is sucked by the working fan 7 from a back side thereof under a negative pressure, and blown out from a front side thereof, so that cold air is blow out in a directional manner, which facilitates rapid cooling in a small area of space. The fan 7 is movably connected to the fan frame 1. Specifically, a set of rotating protrusions 701 is arranged on a circumferential outer wall of the fan 7, and the rotating protrusions 701 are movably connected to the support columns 4, so that the fan 7 is capable to adjust an angle of blowing out cold air along an axial direction of the rotating protrusions 701. It is worth mentioning that, as shown in FIG. 6, a first rotating notch 201 is formed at a position of an inner wall of the upper fixed base 2 relative to the fan 7, and a second rotating notch 202 is formed at a position of an inner wall of the lower fixed base 3 relative to the fan 7, where the second rotating notch 202 and the first rotating notch 201 form a movable cavity of the fan 7.

As shown in FIGS. 1-3, a base 8 is arranged at the bottom of the fan frame 1, and a second misting device 9 is arranged at a position of the base 8 relative to the fan 7 in a pull-out manner. As shown in FIG. 2, the second misting device 9 is pulled out from the base 8 to form another humidification state matching the fan 7. The misting device of a pull-out structure has a unique structure, looks beautiful due to hidden design of spray nozzle, and has structural variability. A water collection tank 10 is arranged at a position of the base 8 relative to the first drainage opening 504 in a pull-out manner, to collect ice water flowing out of the first drainage opening 504.

As shown in FIGS. 2, 8 and 9, the second misting device 9 is provided with a water inlet 901 and an air outlet 902, where the water inlet 901 is connected with the second drainage opening 505 through a switching valve 12. Specifically, the second misting device 9 includes an internally hollow mounting base 903, and four sets of atomizing sheets 904 are arranged on the top of the mounting base 903. It is worth emphasizing that when the second misting device 9 is pulled out from the base 8 to form another humidification state matching the fan 7, working positions of the atomizing sheets 904 are arranged on a front side of the fan 7. A liquid level sensor (not shown in the figure) is arranged at a low point relative to the atomizing sheets 904 inside the mounting base 903, and the liquid level sensor is in signal connection to the switching valve 12. The working principle is that: when water in the water tank 507 flows into the switching valve 12, an outlet of the switching valve 12 is communicated with the water inlet 901 through a hose, so that water flows into the mounting base 903; under the action of a communicating vessel, water flows from the high-level water tank 507 into the low-level mounting base 903, and when the water level inside the mounting base 903 rises to the position of the liquid level sensor, the liquid level sensor is capable to control the opening and closing of the switching valve 12 through a control circuit (prior art), thereby controlling the flow of water from the water tank 507 to the mounting base 903 and a water pressure thereof; and combined with the high-frequency vibration of the atomizing sheets 904, automatic replenishment can be achieved, and in addition, by controlling the flow rate and water pressure inside the mounting base 903, leakage of the atomizing sheets 904 due to high water pressure can be avoided.

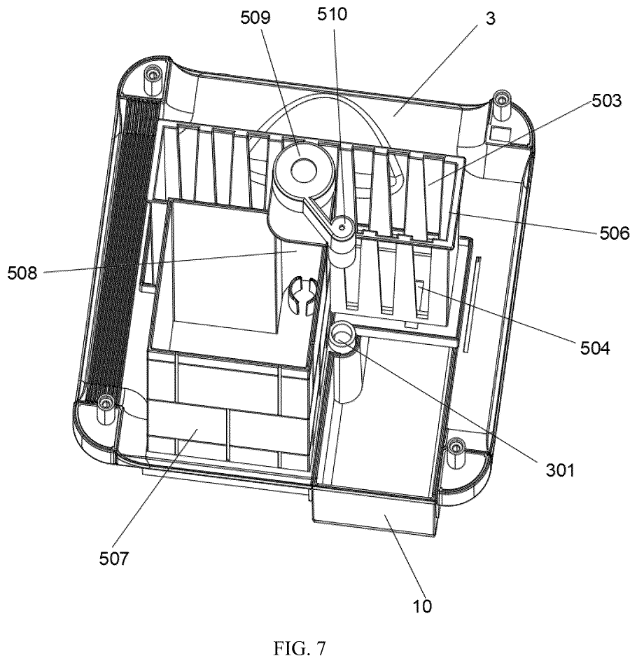

As shown in FIG. 7, the water inlet 901 is arranged at a low end of a back side of the mounting base 903, and the air outlet 902 is arranged at a high end of a back side of the mounting base 903, to facilitate the flow of water inside the mounting base 903. It is worth mentioning that a through hole 301 is formed on at a position of the lower fixed base 3 relative to a connecting angle between the ice box 506 and the water tank 507, an air guide socket 510 is arranged at a position on a surface of the atomizer 509 relative to the through hole 301, an end portion of the air outlet 902 is sleeved with an exhaust hose (not shown in the figure), and an end of the exhaust hose penetrates through the through hole 301 and is in fit with the air guide socket 510 in an inserted manner, so that the exhaust hose is hidden at a corner, thus improving the aesthetic degree.

In addition, a heat dissipation device 11 is arranged on a side surface of the fan frame 1, and lighting can be arranged on another side surface thereof to enhance the sense of technology.

The disclosed embodiments of the present disclosure are preferred embodiments, but it is not intended to limit the scope of the present disclosure. Those of ordinary skill in the art can easily understand the spirit of the present disclosure and make different extensions and changes according to the above embodiments. However, without departing from the spirit of the present disclosure, such extensions and changes all fall within the protection scope of the present disclosure.

What is claimed is:

1. An ice-misting cooling fan, comprising a fan frame (1) formed by movably assembling an upper fixed base (2), a lower fixed base (3) and a plurality of support columns (4), wherein a first misting device (5) is arranged inside the fan frame (1);
the first misting device (5) is provided with a first placing opening (501), a second placing opening (502), a cold air outlet (503), a first drainage opening (504)and a second drainage opening (505);
the first placing opening (501) and the second placing opening (502)are covered by an end cover (6) that is movably connected to the fan frame (1);
a fan (7) is arranged on an outer side of the cold air outlet (503) to guide the circulation of cold air, and the fan (7)is movably connected to the fan frame (1);
a base (8) is arranged at the bottom of the fan frame (1), a second misting device (9) is arranged at a position of the base (8) relative to the fan (7) in a pull-out manner, and a water collection tank (10) is arranged at a position of the base (8) relative to the first drainage opening (504) in a pull-out manner; and
the second misting device (9) is provided with a water inlet (901) and an air outlet (902), wherein the water inlet (901) is connected with the second drainage opening 505 through a switching valve (12).

2. The ice-misting cooling fan according to claim 1, wherein a set of rotating protrusions (701) is arranged on a circumferential outer wall of the fan (7), and the rotating protrusions (701) are movably connected to the support columns (4); and
a first rotating notch (201) is formed at a position of an inner wall of the upper fixed base (2) relative to the fan (7), and a second rotating notch (202) is formed at a position of an inner wall of the lower fixed base (3) relative to the fan (7), wherein the second rotating notch (202) and the first rotating notch (201) form a movable cavity of the fan (7).

3. The ice-misting cooling fan according to claim 1, wherein the first misting device (5) comprises an ice box (506) and a water tank (507) that are fixedly connected, and the first placing opening (501)is formed at the top of the ice box (506); the cold air outlet (503)is arranged on a front side of the ice box (506); the first drainage opening (504) is formed on the lower fixed base (3); the second placing opening (502) is formed at the top of the water tank (507); and the second drainage opening (505) is formed at the bottom of the water tank (507).

4. The ice-misting cooling fan according to claim 3, wherein the first misting device (5) further comprises a housing (508) arranged along a normal line of an intersection between the ice box (506) and the water tank (507), and a cotton core mounting cavity is formed inside the hollow housing (508); an atomizer (509) is fixedly installed at the top of the housing (508), and an opening is formed at a position of the end cover (6) relative to a nozzle of the atomizer (509).

5. The ice-misting cooling fan according to claim 4, wherein a through hole (301) is formed on at a position of the lower fixed base (3) relative to a connecting angle between the ice box (506) and the water tank (507), an air guide socket (510) is arranged at a position on a surface of the atomizer (509) relative to the through hole (301), an end portion of the air outlet (902) is sleeved with an exhaust hose, and an end of the exhaust hose penetrates through the through hole (301) and is in fit with the air guide socket (510) in an inserted manner.

6. The ice-misting cooling fan according to claim 5, wherein the second misting device (9) comprises an internally hollow mounting base (903),and a plurality of atomizing sheets (904) are arranged on the top of the mounting base (903); a liquid level sensor is arranged at a low point relative to the atomizing sheets (904) inside the mounting base (903), and the liquid level sensor is in signal connection to the switching valve (12); and the water inlet (901) is arranged at a low end of a back side of the mounting base (903), and the air outlet (902) is arranged at a high end of a back side of the mounting base (903).

7. The ice-misting cooling fan according to claim 6, wherein working positions of the atomizing sheets (904) are arranged on a front side of the fan (7).

8. The ice-misting cooling fan according to claim 1, wherein at least one heat dissipation device (11) is arranged on a side surface of the fan frame (1).
